(19) United States
(12) Patent Application Publication
(10) Pub. No.: US 2014/0034802 A1
(43) Pub. Date: Feb. 6, 2014

(54) Motorized flat panel television track device

(71) Applicant: Leslie Dale Robbins, San Diego, CA (US)

(72) Inventor: Leslie Dale Robbins, San Diego, CA (US)

(21) Appl. No.: 13/562,325

(22) Filed: Jul. 31, 2012

(51) Int. Cl. F16M 13/00

(52) U.S. Cl. 248/610; 248/323

(57) ABSTRACT

A moveable support system for a video monitor comprised of a straight or curved overhead mounted track, a support tube with a rotating head to which the monitor is attached, and a wireless remote which controls the position along the track as well as the rotational angle of the monitor. The track provides mechanical support for the monitor as well as a conduit for the retractable wiring and cabling which connects the wall or cabinet mounted base unit to the monitor. This system allows movement to any position along the overhead mounted track as well as variable angular position of the monitor with respect to the vertical axis of the support tube.

### SUMMARY OF THE INVENTION

The present invention relates to a support system for at least one display device. This display support system is comprised of an overhead mounted track that defines a straight or curved path along which the monitor may move, a vertical support member from which the monitor is suspended and mechanisms which provide for cable management as well as power assisted movement along the track and rotational movement of the monitor to provide various viewing angles. The monitor is capable of power assisted rotation approaching 360 degrees at any location along the track. Movement along the track is provided by wheels riding on a pair of parallel rails contained within the overhead track. Also, suspension springs within the overhead mechanism provide for substantial robustness and damping in cases where a person accidentally bumps the monitor, causing it to sway. A limited slip mechanism provides for robustness within the rotational mechanism. Cable extension and retraction within the track is provided for by a flexible coiled tube through which all related electrical connections pass.

### DETAILED DESCRIPTION OF EXEMPLARY EMBODIMENTS

Embodiments of the invention are discussed below in detail. In describing embodiments, specific terminology is employed for the sake of clarity. However, the invention is not intended to be limited to the specific terminology used. While specific exemplary embodiments are discussed, it should be understood that this is done for illustrative purposes only. A person skilled in the relevant art will recognize that other components and configurations can be used without parting from the spirit and scope of the invention.

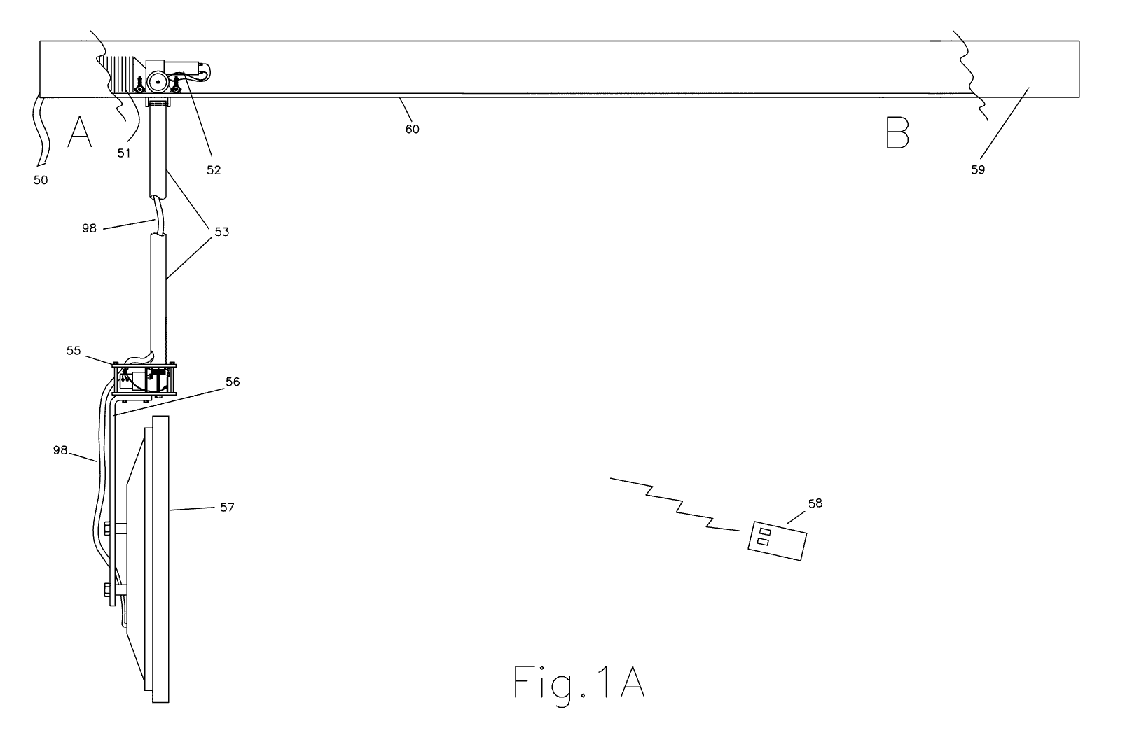

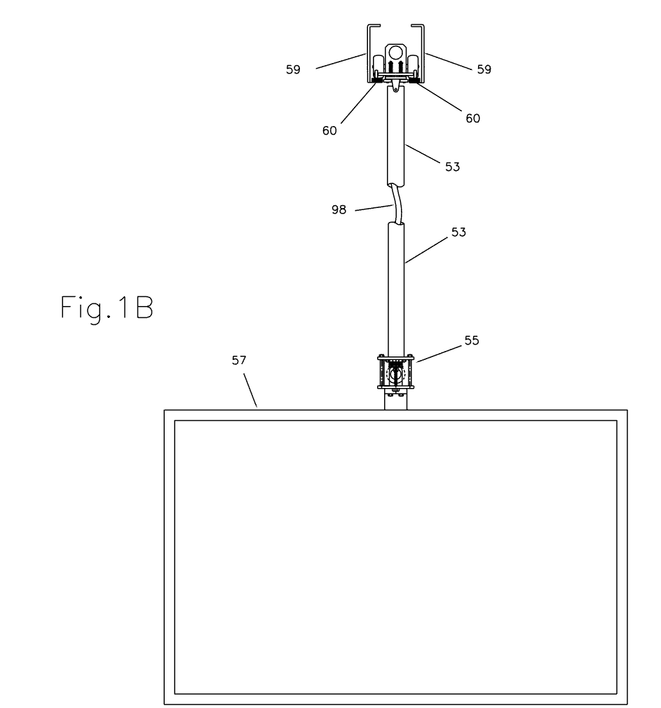

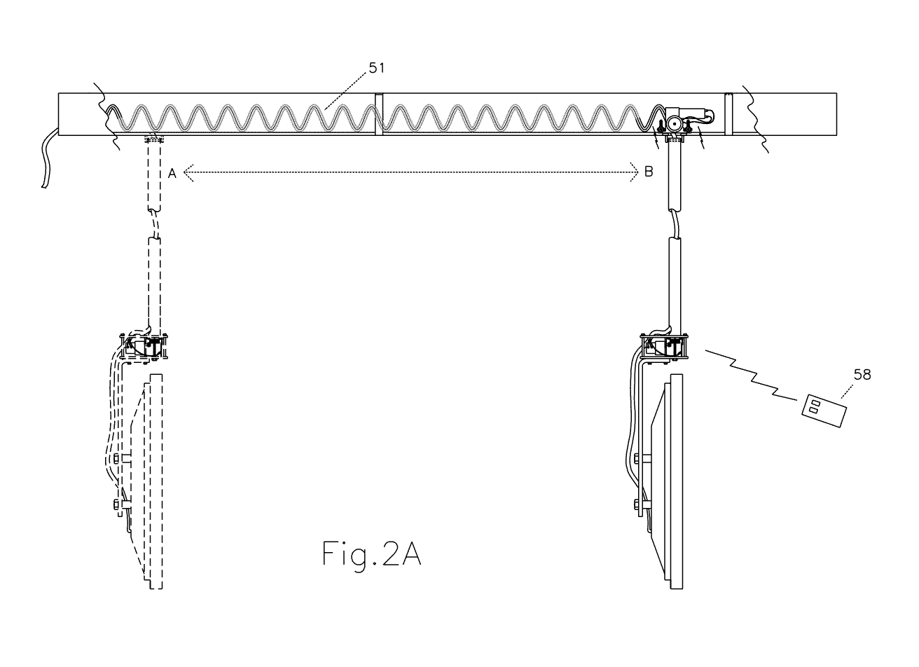

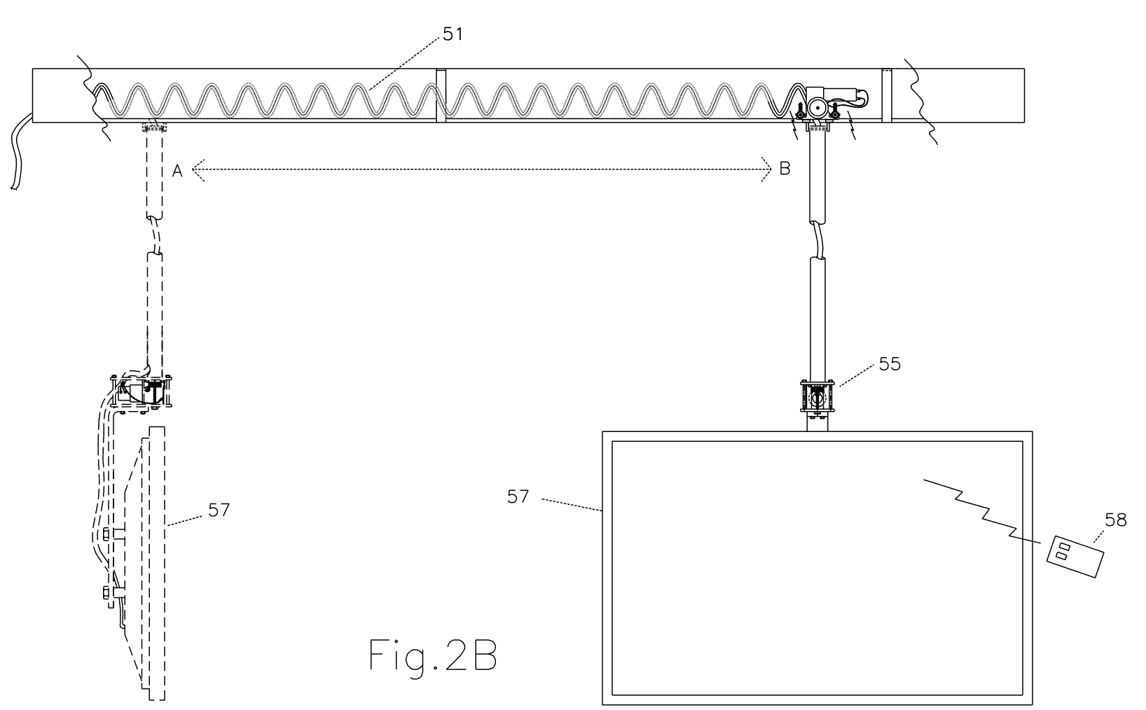

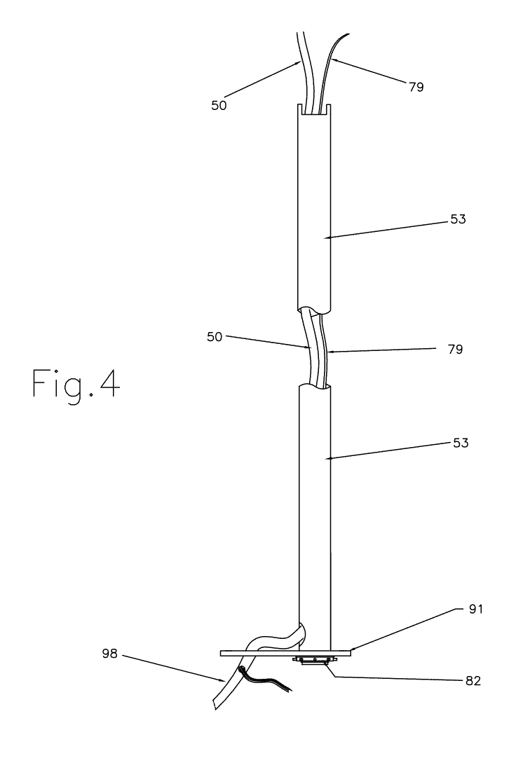

FIG. 1A shows a side view of a display support system for a moveable display device according to an exemplary embodiment of the present invention. The display support system includes a track system, a cable management system enclosed in the track system (see FIGS. 1A, 1B, 2A, 2B) and a vertical support member FIG. 4, which is moveably engaged with the track system for supporting the movement and rotation of the display device 57 along a display movement path defined by the overhead track. The vertical support member 53 is capable of being moved from point A to any point in between Point A and Point B and rotated to a desired viewing angle and position. Point A along the display movement path corresponds to the starting movement point, where the movement of the display device begins. Point B along the display movement path corresponds to the farthest movement point, where the movement of the display device ends. Depending on user requirements, the length and path of the track system can be configured to accommodate a wide variety of display movement paths, including straight, curved, and/or angled sections in any combination. FIG. 1A shows a straight path, however, this is not to be construed as limiting this to non-curved and non-angled paths.

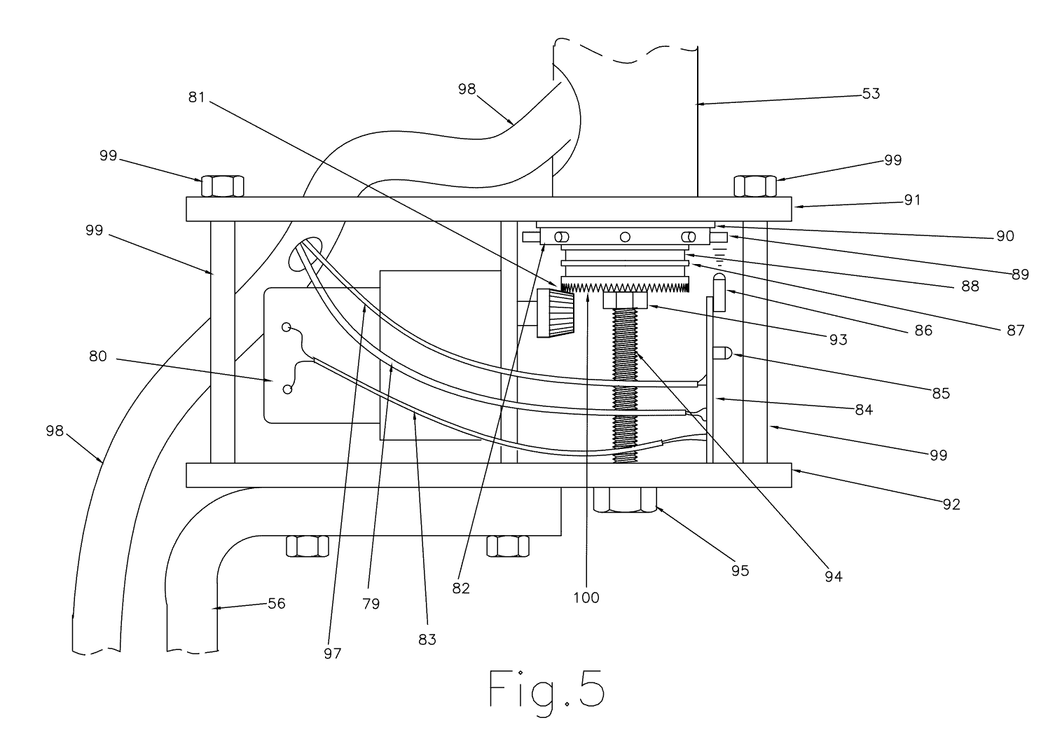

As shown in FIG. 1A, cabling enters the display support system track at 50. These cables are routed through a flexible spiral tube 51 made of a flexible material such as vinyl, polyurethane, or other material with similar properties and these cables link into the motorized carrier 52. Cables are further routed through the vertical support tube 53 & FIG. 4 to the motorized pivot head FIG. 5 and finally to the display monitor 57 to provide power and signal for displaying user selectable content such as video, signage, and an infinite variety of other display content. The display monitor is suspended from the support tube 53 by the support bracket 56. A wireless remote control 56 provides for control of the both the linear movement along the track as well as rotational movement of the display 57 angle.

As shown in FIG. 2A, the wireless remote 58 actuates the motorized carrier 52, which moves the support tube 53 and monitor 57 to any desired position along the track rails 60. Additionally, as shown in FIG. 2B, the wireless remote 58 actuates the motorized pivot head 55 to adjust the viewing angle to accommodate the preference of the user and room configuration.

A cosmetic cover 59 FIG. 1A including support brackets, and the rails 60 FIG. 1B define the path of the display support system and provide physical support for the suspension and movement of the display.

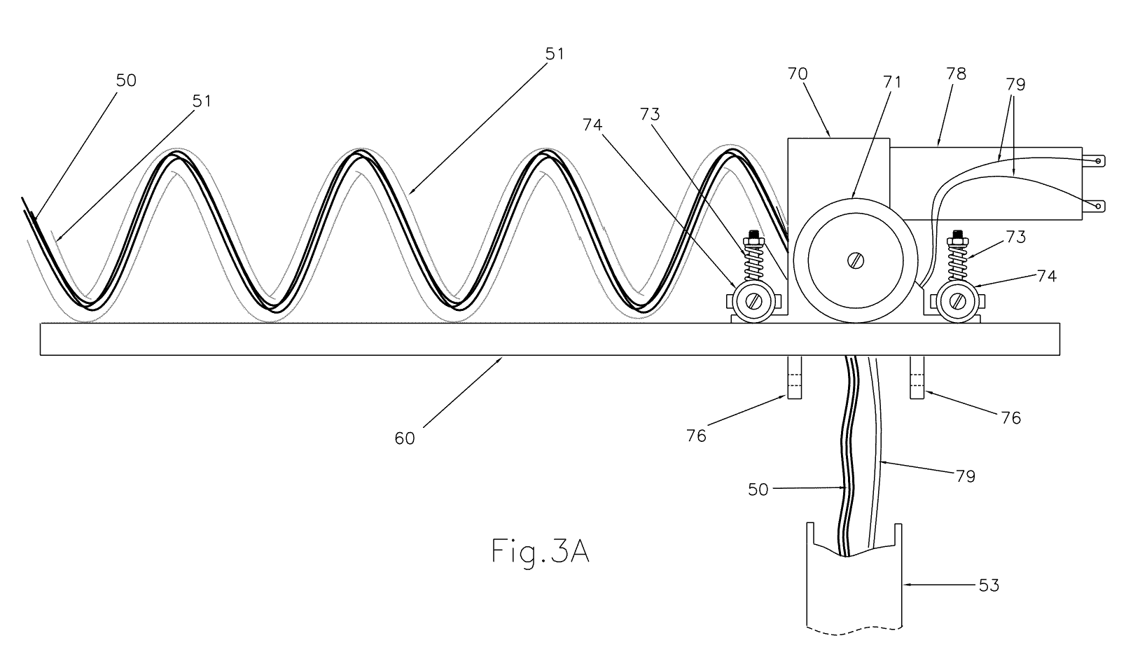

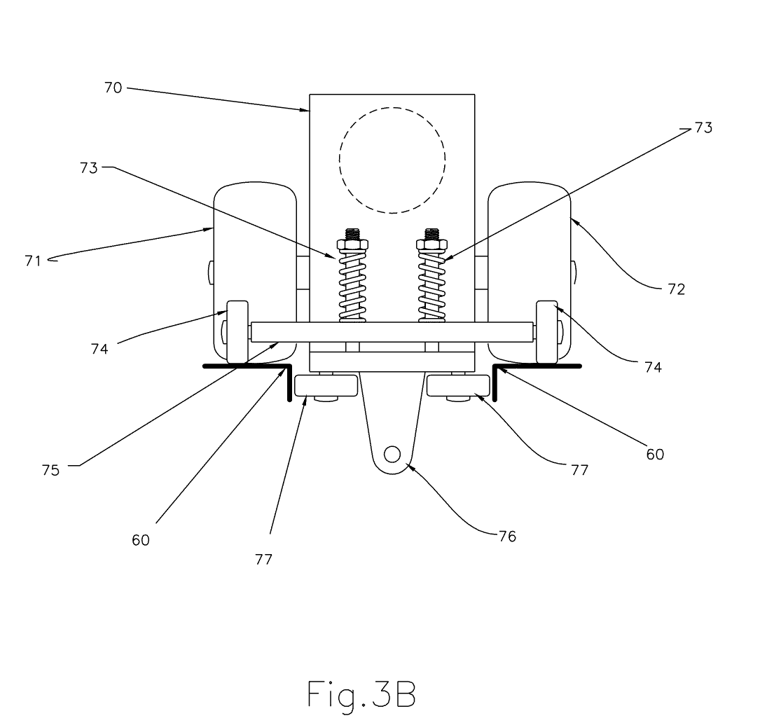

FIG. 3A shows the flexible coil tube 51 and the motorized carrier 52. Cables and wires are routed through the flexible coil tube 51, which rides on the rails 60 as the motorized carrier 52 moves along its path. The flexible coil tube 51 is attached in a fixed position at starting point A FIG. 1A where the cables and wires enter the tube. The other end of the flexible coil tube 51 is attached to the motorized carrier 52, then cables and wires are routed down through the vertical support tube 53 to the motorized pivot head 55 where several wires 97 exit and are attached to the master control board 84. Control wires 83 are attached to the master control board 84 FIG. 3B and are routed to the motor 80 and mechanisms of the motorized pivot head 55. Control wires 79 for the motorized carrier 52 are routed from the master control board 84 (located in the motorized pivot head 55) back up through the vertical support tube 53 to the motor 78 FIG. 3A and mechanisms of the motorized carrier 52. The vertical support tube is attached to the motorized carrier 52 on the vertical tube support bracket 76.

The cables and wires which provide power and signal to the display monitor 57 are routed thru the flexible coil tube 51 down through the vertical support tube 53 and continue down in a cable routing bundle 98 through the motorized pivot head 55 and down to the terminals on the display monitor 57.

FIGS. 3A and 3B show details of the motorized carrier 52. The motorized carrier 52 is composed of a suspension system and a drive system. The suspension system consists of suspension wheels 74 which ride on top of the rails 60 and guide wheels 77 which are located between the two rails. The guide wheels 77 keep the motorized carrier 52 aligned with the rails 60 and limit sideways and rotational movement. The suspension wheels 74 are attached to a sway stabilizer bar 75 which rests against the sway stabilizer springs 73. There are two sway stabilizer bars 75, one on the leading end of the motorized carrier 52, and one on the trailing end of the motorized carrier 52 which are attached to the carrier housing 70. These sway stabilizer bars 75, along with the suspension wheels 74 and suspension springs 73 provide a dual purpose suspension system. Firstly, they provide a damping mechanism to stabilize the vertical position of the vertical support tube 53 and reduce sway during movement of the motorized carrier 52 and during an accidental bump of the display by any occupant of the room. Secondly, this suspension system reduces the maximum load upon the axle and drive of the motor mechanism located in the motorized carrier 52. The drive system is composed of a motor and gears contained in the carrier housing 70 driving a single drive wheel 71 that contacts the rails 60 and moves the motorized carrier 52 down the track. A free wheel 72 is provided on the opposite side and rides on the opposite rail to balance the load from the weight of the display.

FIG. 4 shows the routing of the cables and wires through the vertical support tube 53.

FIG. 5 shows details of the motorized pivot head 55. The motorized pivot head 55 provides power and control of the rotational position of the display 57. The motorized pivot 55 head also houses the master control board 84 which interacts with the wireless remote 58 as well as all movement and rotation of the display support system. The master control board 84 reads information from the wireless remote via the IR detector 85, translates this into commands which control the pivot motor 80, the optical encoder 86, and the motorized carrier motor 78. The master control board 84 is capable of reading rotational position via the optical encoder 86 and the position markers 89. The control board is capable of storing the position of the motorized carrier 52 on the track and rotational position of the motorized pivot head 55, so that the user can press a button on the wireless remote 58 to send the display unit to home position at Point A FIG. 2A, then later activate the stored location and then the display returns to the previously saved position and rotation angle. The pivot motor is controlled by the master control board. Differential gears 81 provide rotational force to rotate the motorized pivot head 55 and its attached display 57. Other key features of the motorized pivot 55 head are the cluster of the nylon washer 90, pivot collar 82, nylon plates 88, metal plate 87, tension shaft 94, load carrying adjustment nut 95 and limited slip adjustment nut 93.

The load carrying adjustment nut 95 reduces the downwards pressure on the nylon washer 90, thereby reducing the force needed to turn the motorized pivot head 55 with respect to the vertical support tube 53.

The limited slip adjustment nut 93 provides adjustment of the amount of rotational tension that will be accumulated before the limited slip mechanism starts to slip and allow rotation of the ring gear 100 FIG. 5 with respect to the vertical support tube 53. The purpose of the limited slip mechanism is to allow the display to rotate in cases of a person bumping the edge of the display and allowing it to turn rather than damage gears or other mechanisms in the motorized pivot head 55.

The upper body plate 91 and the lower body plate 92 together with the fasteners 99 provide the structure to which the motor and mechanism of the motorized pivot head 55 are attached. The bracket 56 which supports the weight of the display 57 is attached to the lower body plate 92.

1. A support system mounted to a ceiling and defining a horizontal linear or curved path along which the display can be moved and rotated at any point along the path; a vertical support tube suspending the display from the ceiling mounted support system; a flexible coiled tube cable and wiring management system contained within the ceiling mounted support system and able to stretch to accommodate any position along the predetermined path defined by the ceiling mounted support system.

2-5. (canceled)

6. The system according to claim #1 where a rotational head is attached to the vertical support tube and contains a limited slip mechanism consisting of layers of nylon or similar material and metal discs and a tension adjustment which allows gears to be protected from damage when subject to excessive torque.

7. The system according to claim #6 where a device can be moved and rotated up to 360 degrees in one direction or another and aimed to accommodate various uses such as, but not limited to, LCD or Plasma display, remote monitoring cameras, or other apparatus attached to the rotational head of claim #6.

8. A drive mechanism comprised of a motorized carrier which rides along a railed track contained within the ceiling mounted support system and comprised of 2 or more wheels riding on the railed track and having at least one motor driven wheel driving the carrier along the path by contact of the wheel on at least one of the rails.

9. A suspension system attached to the carrier according to claim #8 and the vertical support tube of the display comprised of two or more sets of spring mounted wheels riding on one or more rails and providing sway damping and stabilization of the vertical support tube and attached display.

10. A guide mechanism attached to the carrier according to claim #8 comprised of four or more wheels attached to the carrier and riding in between the two rails of a ceiling mounted moveable support system and riding against the inner edges of the rails and preventing rotation of the movable carrier to which the vertical support tube is attached and to provide alignment with the rail position, angle and curvature.
